(19) United States
(12) Patent Application Publication
(10) Pub. No.: US 2002/0195860 A1
(43) Pub. Date: Dec. 26, 2002

(54) Electric-motor adjustment device for an automobile seat

(75) Inventors: Guillaume Caupin, Grobenzell (DE); Christoph Schedler, Haar (DE); Harald Spaet, Neufahrn (DE)

Correspondence Address: Bourque & Associates, P.A., Suite 301, 835 Hanover Street, Manchester, NH, 03104, US

(73) Assignee: Faurecia Autositze GmbH & Co. KG

(21) Appl. No.: 10/174,618

(22) Filed: Jun. 19, 2002

(30) Foreign Application Priority Data
Jun. 20, 2001 (DE) 101 29 728.9

(51) Int. Cl. B60N 2/10; H02P 1/00; H02P 1/40

(52) U.S. Cl. 297/367; 318/291

(57) ABSTRACT

An electric-motor adjustment device for an automobile seat with a direct-current (DC) motor positioned in an electrical circuit whose rotation direction may be reversed, and which motor includes a drive wheel that drives an adjustable drive element for an adjustable seating area, is connected in series with additional electronic components. These additional components include a linear resistor and a current blocking device operating in only one current-flow direction, which are wired together in parallel and then the combination in series with the DC motor. This has the result that, in a first current-flow direction, the current flows through the DC motor to drive it in the first rotation direction, and through the linear resistor. In the opposing second current-flow direction, the current flows through the DC motor to drive it in the second rotation direction, and essentially through the blocking device which does not block the current flow in this direction and which bridges the linear resistor.

### TECHNICAL FIELD

The invention relates to an electric-motor adjustment device for an automobile seat.

### BACKGROUND INFORMATION

The adjustment speeds for individual seat functions can be quite varied. For example, an automobile seat may be moved rearward more quickly than forward along a longitudinal adjustment rail inclined at about 6°. Similarly, a headrest provided with numerous functional elements moves downward much quicker than it does upward.

The varying movement speeds in the various movement directions can be bothersome to the user.

### SUMMARY OF THE INVENTION

The invention relates to an electric-motor adjustment device having the adjustment speeds the same in various adjustment directions.

In the solution provided by the invention, the quicker adjustment process not requiring any extra measures is so delayed that, upon adjustment in this direction, a linear resistor is active in the circuit that is bridged upon rotation of the motor in the opposite direction via a blocking device operating only in one direction of current flow.

The direction-dependent current-flow blocking device is preferably a diode.

### BRIEF DESCRIPTION OF THE DRAWINGS

These and other features and advantages of the present invention will be better understood by reading the following detailed description, taken together with the drawings wherein:

FIG. 1 is a schematic circuit diagram of the preferred embodiment of the invention.

### DETAILED DESCRIPTION OF THE PREFERRED EMBODIMENTS

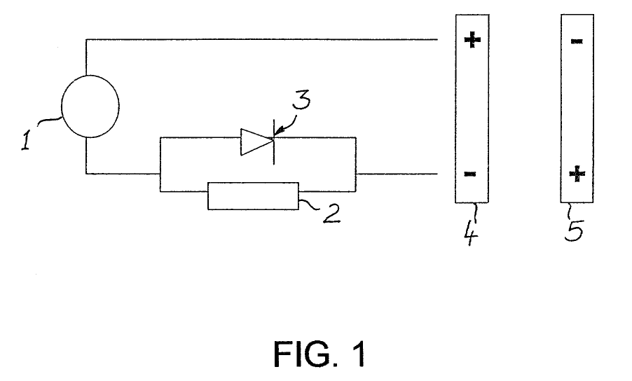

Referring to FIG. 1, A direct-current (DC) motor 1 is in an electrical circuit. Further, this circuit contains a linear resistor 3 in parallel with a direction-dependent current-flow blocking device in the form of a diode 3.

The linear resistor 2 and the diode 3 are connected in series with the DC motor. By means of a switch 4, power is provided to the circuit from the positive pole via the direct current and through the diode to the negative pole. Since the diode 3 provides practically no resistance in this current direction, it bridges the linear resistor in such a manner thatvirtually no current flows through the linear resistor 2.

In the opposing current direction, current again flows from the positive pole through the linear resistor 2 by means of the switch 5, and then through the DC motor to the negative pole. For this current-flow direction, the diode 3 blocks the current to the point that the current must flow exclusively through the linear resistor 2 and the DC motor 1. This current-flow direction corresponds to the accelerated adjustment direction without the presence of the illustrated circuit diagram. The linear resistor 2 represents an additional current consumer in this current direction whose current consumption leads to a voltage drop resulting in a DC motor output reduction in this direction, so that the DC motor 1 turns as fast in this direction as in the opposite direction in which the linear resistor 2 is bridged by the diode 3.

What is claimed is:

1. An electric-motor adjustment device for an automobile seat with a direct-current (DC) motor positioned in an electrical circuit, in which the motor rotation direction may be switched, and which is connected to a drive wheel that drives an adjustable drive element connected to an adjustable seating area, the circuit further comprising a linear resistor and a current blocking device effective in only one current-flow direction are wired together in parallel, and the combination wired in series with the DC motor in such a manner that, in a first current-flow direction, current flows through the DC motor for its operation in the first rotational direction and through the linear resistor (2), and in a second, opposite, current-flow direction, the current flows through the DC motor for it's operation in the opposite rotational direction, and through the blocking device which permits the current flow in this direction and bridges the linear resistor.

2. The electric-motor adjustment device as in claim 1, wherein the direction-dependent current-flow blocking device comprises a diode (3).

3. The electric-motor adjustment device as in claim 1, wherein the current-flow directions in the circuit may be reversed by means of a switch.

4. The electric-motor adjustment device as in claim 2 wherein the current-flow directions in the circuit may be reversed by means of a switch.
